(19) United States
(12) Patent Application Publication
(10) Pub. No.: US 2013/0044232 A1
(43) Pub. Date: Feb. 21, 2013

(54) CAMERA, CONTRL METHOD THEREOF, CAMERA SYSTEM USING THE SAME

(71) Applicant: Xianzhi ZHANG, Shenzhen (CN)

(72) Inventor: Xianzhi ZHANG, Shenzhen (CN)

(73) Assignee: SHENZHEN AEE TECHNOLOGY CO., LTD.

(21) Appl. No.: 13/352,329

(22) Filed: Jan. 17, 2012

(30) Foreign Application Priority Data
Aug. 19, 2011 (CN) 201110239941.7

(51) Int. Cl. H04N 5/232

(52) U.S. Cl. 348/211.99; 348/E05.042

(57) ABSTRACT

A camera includes a first wireless module configured for receiving wireless remote control signals, a first microcontroller configured for converting the wireless remote control signals to executing commands and outputting the executing commands, a digital signal processor configured for receiving the executing commands; and an image sensor controlled to obtain image information of a to-be-captured image by the digital signal processor after the executing commands are received. The camera is capable of working in a regular mode and being controlled to work in a remote control mode, which is convenient for the user to use the camera. Also, the remote control device is capable of displaying working states of the camera to allow the user to monitor the performance of the camera. Furthermore, the signals transmitted between the camera and the remote control device can be encrypted for providing a reliable mechanism of data transmission of the signals.

### BACKGROUND

1. Technical Field

The present disclosure relates to camera technologies, and particularly, to a camera, a control method thereof, and a camera system using the camera.

2. Description of Related Art

With the development of camera technologies, cameras have become prevailing in various industries. People not only require that the images outputted from the cameras have high definition and high resolution, but also require that functions of the cameras be expanded to satisfy particular requirements.

Generally, a camera can be used for recording images and recording sound. These images may be still photographs or moving images such as videos or movies. A user can choose a corresponding working mode of the camera such as image recording mode, sound recording mode via a control module of the camera. Also, the user can set parameters for each working mode by operating the control module, thereby adjusting properties such as definitions or resolutions of images outputted from the camera, or the sound recording time. The recorded images or recorded sound can be stored in a memory of the camera or can be transferred to a display of the camera for being displayed or played.

However, the camera cannot work in a remote control mode, and the user should hold the camera with one hand and operate the camera with the other hand when using the camera, which is inconvenient for the user, especially for some professional users.

Therefore, there is room for improvement in the art.

### SUMMARY

One object of the present disclosure is to provide a camera which can work in a remote control mode. The camera includes a first wireless module, a first microcontroller, a digital signal processor, and an image sensor. The first wireless module is configured for receiving wireless remote control signals. The first microcontroller is configured for converting the wireless remote control signals to executing commands and outputting the executing commands. The digital signal processor is configured for receiving the executing commands. The image sensor is controlled to obtain image information of a to-be-captured image by the digital signal processor after the digital signal processor receives the executing commands.

Preferably, the digital signal processor is further configured for outputting a working state signal of the image sensor, and the first microcontroller is further configured for converting the working state signal to a wireless feedback signal and transmitting the wireless feedback signal to the first wireless module to allow the wireless feedback signal to be outputted by the first wireless module.

Preferably, the first microcontroller is further configured for decrypting the wireless remote control signals after the wireless remote control signals are received and encrypting the wireless feedback signal before outputting the wireless feedback signal.

Another object of the present disclosure is to provide a remote control method of a camera. The remote control method includes the following steps: receiving wireless remote control signals; converting the wireless remote control signals to executing commands; controlling an image sensor of the camera to obtain image information of a to-be-captured image according to the executing commands.

Preferably, the remote control method further includes the following steps: converting working state signals of the image sensor to wireless feedback signal; outputting the wireless feedback signal.

Preferably, the remote control method further includes decrypting the wireless remote control signals after the step of receiving the wireless remote control signals and encrypting the wireless feedback signal before the step of outputting the wireless feedback signal.

Still another object of the present disclosure is to provide camera system. The camera system includes a remote control device configured for outputting wireless remote control signals and a camera. The camera includes a first wireless module, a first microcontroller, a digital signal processor, and an image sensor. The first wireless module is configured for receiving the wireless remote control signals from the remote control device. The first microcontroller is configured for converting the wireless remote control signals to executing commands and outputting the executing commands. The digital signal processor is configured for receiving the executing commands. The image sensor is configured for being controlled to obtain image information of a to-be-captured image by the digital signal processor after the digital signal processor receives the executing commands.

Preferably, the digital signal processor is further configured for outputting working state signals of the image sensor, and the first microcontroller is further configured for converting working state signals to wireless feedback signal and transmitting the wireless feedback signal to the first wireless module to allow the wireless feedback signal to be outputted by the first wireless module.

Preferably, the first microcontroller is further configured for decrypting the wireless remote control signals received by the first wireless module and encrypting the wireless feedback signal.

Preferably, the remote control device comprises a second control module, a second microcontroller, and a second wireless module, the second control module is configured for receiving operation commands, the second microcontroller is configured for receiving the operation commands outputted from the second control module and converting the operation commands to wireless remote control signals, and the second wireless module is configured for matching with the first wireless module and transmitting the wireless remote control signals to the first wireless module.

Preferably, the remote control device further comprises a second display, the second wireless module is further configured for receiving the wireless feedback signal outputted from the first wireless module, and the second microcontroller is further configured for converting the wireless feedback signal to executing state signals and outputting the executing state signals to the second display for display.

Preferably, the second microcontroller is further configured for encrypting the wireless remote control signals before transmitting the wireless remote control signals and decrypting the wireless feedback signal after the wireless feedback signal is received.

The camera of the present disclosure can work in the remote control mode to allow the user to remotely control the camera, which is convenient. Since the camera can work in the remote control mode, wires for connecting the camera and the remote control device can be omitted, which is convenient for the user to install and use the camera. Additionally, the user can obtain the performance of the camera by observing the working states of the camera shown in the remote control device. Furthermore, the signals transmitted between the camera and the remote control device can be encrypted for providing a reliable mechanism for signal transmission between the camera and the remote control device.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view of a camera system in one embodiment of the present disclosure.

FIG. 2 is a detailed schematic view of the camera system of FIG. 1.

FIG. 3 is a flow chart of a control method of a camera according to an embodiment of the present disclosure.

FIG. 4 is a flow chart showing the step of converting a working state signal of an image sensor to a wireless feedback signal and the step of outputting the wireless feedback signal.

FIG. 5 is a flow chart showing the step of decrypting the encrypted wireless remote control signals.

FIG. 6 is a flow chart showing the step of encrypting the wireless feedback signal.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

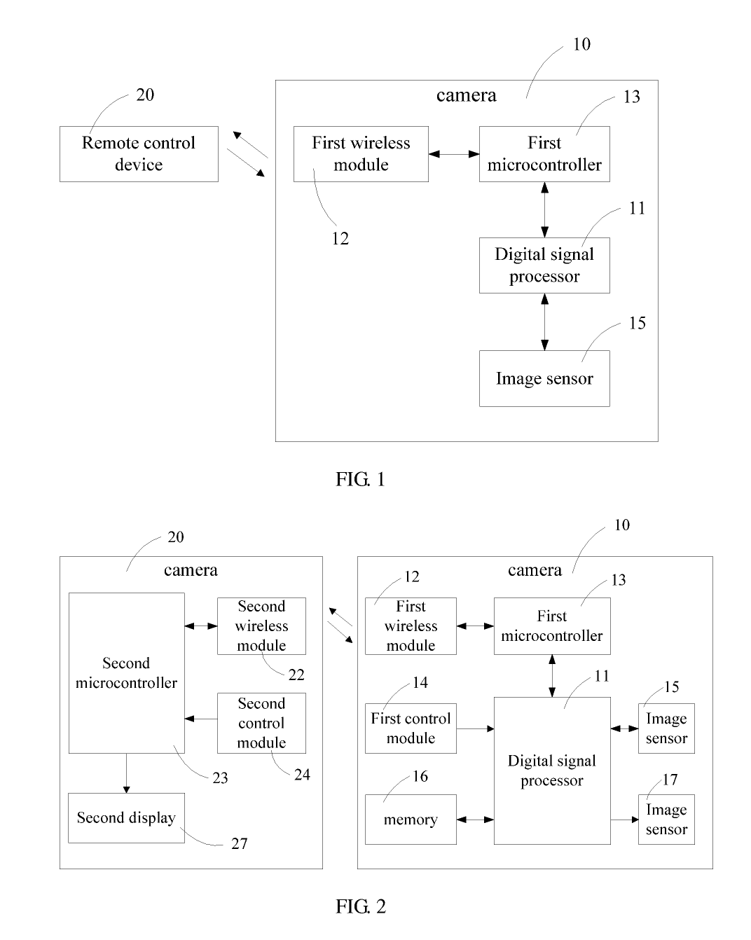

Referring to FIGS. 1 and 2, the present disclosure provides a camera system. In one embodiment, the camera system includes a camera 10 and a remote control device 20 capable of transmitting to and receiving wireless signals from the camera 10.

The camera 10 includes a digital signal processor 11, a first wireless module 12, a first microcontroller 13, a first control module 14, an image sensor 15, a memory 16, and a first display 17. The remote control device 20 includes a second wireless module 22, a second microcontroller 23, a second control module 24, and a second display 27.

The second control module 24 is configured for receiving operation commands from a user. The second microcontroller 23 receives the operation commands from the second control module 24 and converts the operation commands to wireless remote control signals. In the embodiment, the wireless remote control signals can be wireless signals communicable between the remote control device 20 and the camera 10, such as radio wave signals, infrared remote control signals, Bluetooth signals, GPRS (general packet radio service) signals, CDMA (code division multiple access) signals, WIFI (wireless fidelity) signal, and 3G (3rd-generation) signals, etc. The second wireless module 22 receives the wireless remote control signals and further transmits the wireless remote control signals to the camera 10. It is noted that in the illustrated embodiment, the second wireless module 22 is configured being a transceiver for transmitting and receiving signals. That is, the second wireless module 22 not only receives signals from other components, but also transmits signals to other components.

The first wireless module 12 of the camera 10 is configured for matching with the second wireless module 22 of the remote control device 20 and receiving the wireless remote control signals from the second wireless module 22. It is noted that the first wireless module 12 is also configured being a transceiver for transmitting and receiving signals as the second wireless module does.

The first microcontroller 13 is configured for converting the wireless remote control signals received by the first wireless module 12 to executing commands and further transmitting the executing commands to the digital signal processor 11. For example, when the wireless remote control signals transmitted to the first microcontroller 13 are pulse radio wave signals, the first microcontroller 13 converts the pulse signals to the executing commands which are of logical high/low levels and are recognizable by the digital signal processor 11 via a D/A converting unit thereof.

The digital signal processor 11 receives the executing commands and executes the executing commands for controlling the image sensor 15 to obtain image information of a to-be-captured image. Therefore, the user is capable of remotely controlling the camera 10 to take still images or moving images such as videos or movies by the remote control device 20. It is noted that in some embodiments, the camera 10 may also include an audio sensor for obtaining audio/sound information, which allows the user to remotely control the camera 10 to work in a sound recording mode by controlling the audio sensor to obtain the corresponding audio information. Also, in some embodiments, the camera 10 may include a parameter setting module such that the user can remotely set parameters of the camera 10. In this way, the user can control the camera 10 by operating the remote control device 20, which provides a convenient way for the user to user the camera 10.

In some embodiments, the digital signal processor 11 may further be configured for outputting a working state signal indicating a current working state of the image sensor 15. Correspondingly, the first microcontroller 13 may further be configured for converting the working state signal to a wireless feedback signal and outputting the wireless feedback signal to the first wireless module 12. The wireless module 12 receives the wireless feedback signal and transmits the wireless feedback signal to the remote control device 20. The remote control device 20 receives the wireless feedback signal via the second wireless module 22. After the second wireless module 22 receives the wireless feedback signal, the second microcontroller 23 converts the wireless feedback signal to an executing state signal. The executing state signal is processed and transferred to the second display 27 for display. Thus, the working state and performance of the image sensor 15 or the audio sensor or the parameter setting module can be shown in the second display 27 and obtained by the user conveniently.

The first control module 14 in some embodiments is configured for setting the executing commands and outputting the executing commands to the digital signal processor 11. The first control module 14 outputs the executing commands to the digital signal processor 11, which allows the digital signal processor 11 to control the image sensor 15 to obtain the image information, or to control the audio sensor to obtain the audio information, or to control the parameter setting module to set the parameter. The digital signal processor 11 further converts the obtained image information or audio information to image data or audio data. The image data or audio data can be stored in the memory 16 or displayed or played on the first display 17.

It is noted that in some embodiments, for providing a reliable mechanism for signal transmission between the camera 10 and the remote control device 20, the second microcontroller 23 may further be configured for encrypting the wireless remote control signals before the wireless remote control signals are transmitted to the camera 10 and the first microcontroller 13 may correspondingly be configured for decrypting the encrypted wireless remote control signals after the encrypted wireless remote control signals are received. Also, in some embodiments, the first microcontroller 13 may be further configured for encrypting the wireless feedback signal before transmitting the wireless feedback signal to the remote control device 20, and the second microcontroller 20 may correspondingly be configured for decrypting the encrypted wireless feedback signal after the encrypted wireless feedback signal is received.

With the camera system of the present disclosure, wireless signals can be transmitted between the camera 10 and the remote control device 20 with the omission of wires for connecting the camera 10 and the remote control device 20. Thus, it is convenient for the user to install and use the camera 10. Additionally, with the first microcontroller 13, the wireless remote control signals can be converted to the executing commands which can be recognized and executed by the digital signal processor 11. In this state, the digital signal processor 11 is capable of controlling the image sensor 15 to obtain the image information of the to-be-captured image, or controlling the audio sensor to obtain audio information, or controlling the parameter setting module to set the corresponding parameters. Therefore, after the image information of the to-be-captured image or the audio information is obtained, the digital signal processor 11 can convert the image information to image data or converting the audio information to audio data. The image data or the audio data is stored in a memory of the camera 10 for later play or display. Furthermore, the signals transmitted between the camera and the remote control device can be encrypted for providing a reliable mechanism for signal transmission between the camera and the remote control device.

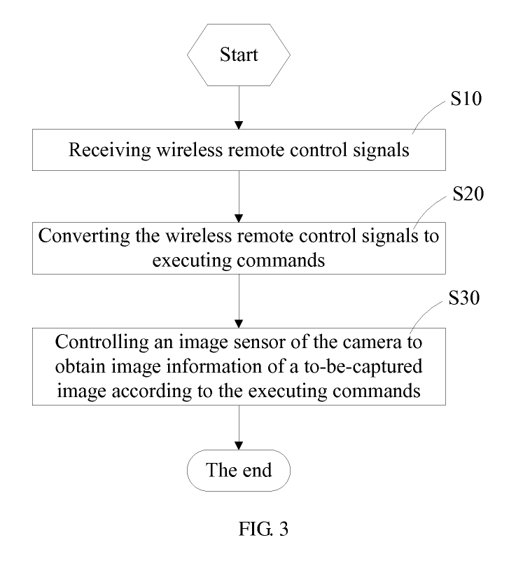

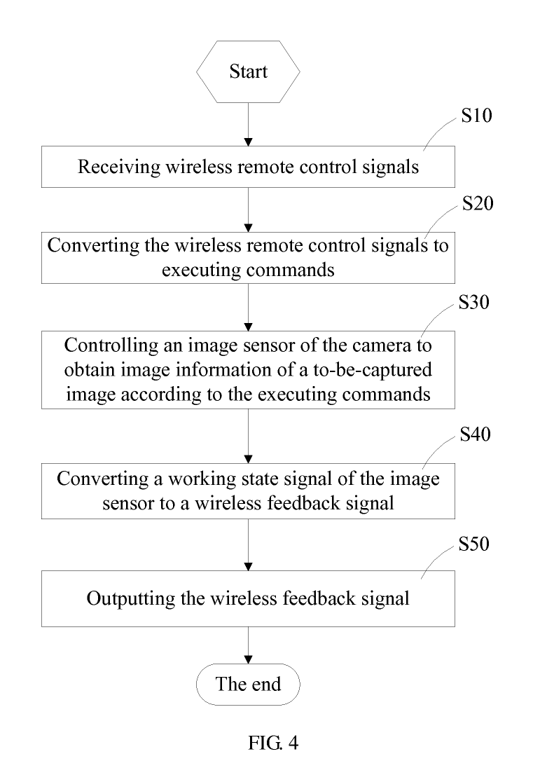

Referring to FIGS. 3 and 4, a control method applied in the camera 10 is provided for allowing the user to control the camera 10 via the remote control device 20. While the control method described below includes a number of steps that appear to occur in a specific order, it should be apparent that the method may include more or fewer steps, which may be executed serially or in parallel (e.g., using parallel processors or a multi-threading environment).

Step S10, receiving wireless remote control signals. The camera 10 in the embodiment includes a first wireless module which is capable of matching with a second wireless module of the remote control device 20 and receiving the wireless remote control signals from the second wireless module such that wireless remote control signals can be transmitted between the camera 10 and the remote control device. In the embodiment, the wireless remote control signals outputted from the second wireless module can be signals which are communicable between the camera 10 and the remote control device 20, such as radio wave signals, infrared remote control signals, Bluetooth signals, GPRS (general packet radio service) signals, CDMA (code division multiple access) signals, WIFI (wireless fidelity) signals, and 3G (3rd-generation) signals, and etc.

Step S20, converting the wireless remote control signals to executing commands. The camera 10 in the embodiment further includes a first microcontroller and a digital signal processor. The first microcontroller converts the wireless remote control signals received by the first wireless module to the executing commands and further transmits the executing commands to the digital signal processor. For example, when the wireless remote control signals transmitted to the first microcontroller are pulse radio wave signals, the first microcontroller converts the pulse signals to the executing commands which are of logical high/low levels and are recognizable by the digital signal processor via D/A converting unit thereof.

Step S30, controlling an image sensor of the camera 10 to obtain image information of a to-be-captured image according to the executing commands. After executing the executing commands, the digital signal processor controls the image sensor to obtain image information of the to-be-captured image. Therefore, the user can control the camera 10 to take still image or take moving images such as movies or videos by controlling the remote control device 20. In some embodiments, the camera 10 may include an audio sensor for obtaining audio information, which allows the user to remotely control the camera 10 to record sound. Also, in some embodiments, the camera 10 may include a parameter setting module capable of being controlled to set the parameters of the camera 10, thus, the user can set the parameters of the camera 10 by operating the remote control device 20. In this way, the user can control the camera 10 conveniently.

Step S40, converting a working state signal of the image sensor to a wireless feedback signal.

Step S50, outputting the wireless feedback signal.

The digital signal processor in some embodiments further outputs a working state signal indicating the current working state of the image sensor. The working state signal is outputted to the first microcontroller and is converted to a wireless feedback signal by the first microcontroller. The first wireless module receives the wireless feedback signal and transmits the wireless feedback signal to the remote control device 20. Thus, the wireless feedback signal can be processed to be shown in display of the remote control device 20 for informing the user of the working state of the image sensor 15 or other components such as the audio sensor or the parameter setting module mentioned above conveniently. This allows the user to obtain the performance of the camera 10 conveniently and thus control the camera 10 effectively.

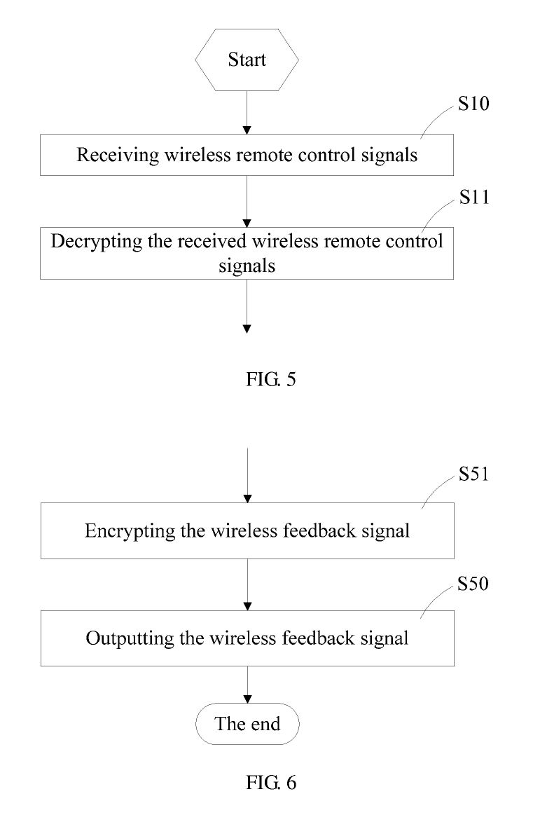

Referring to FIGS. 5 and 6, in some embodiments, the control method may further include two following steps:

in step S11, decrypting the wireless remote control signals received by the first wireless module;

in step S51, encrypting the wireless feedback signal before transmitting the wireless feedback signal to the remote control device 20.

Since at some situations, the remote control device 20 may encrypt the wireless remote control signals before outputting the wireless remote control signals to the camera 10 for providing a reliable mechanism for signal transmission between the camera 10 and the second microcontroller 20, therefore, the first microcontroller 13 can be correspondingly configured for decrypting the encrypted wireless remote control signals. Furthermore, the first microcontroller 13 can also encrypt the wireless feedback signal before wireless feedback signal is transmitted to the remote control device 20.

With the camera system of the present disclosure, wireless signals can be transmitted between the camera 10 and the remote control device 20 with the omission of wires for connecting the camera 10 and the remote control device 20. Thus, it is convenient for the user to install and use the camera 10. Additionally, with the first microcontroller 13, the wireless remote control signals can be converted to the executing commands being recognizable and executable by the digital signal processor 11. In this state, the digital signal processor 11 is capable of controlling the image sensor 15 to obtain the image information of a to-be-captured image, or controlling the audio sensor to obtain audio information, or controlling the parameter setting module to set the corresponding parameters. Therefore, after the image information of the to-be-captured image or the audio information is obtained, the digital signal processor 11 is allowed to convert the image information to image data or converting the audio information to audio data. The image data or the audio data is stored in a memory of the camera 10 for later play or display. Furthermore, the signals transmitted between the camera and the remote control device can be encrypted for providing a reliable mechanism for signal transmission between the camera and the remote control device.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A camera, comprising:
a first wireless module configured for receiving wireless remote control signals;
a first microcontroller configured for converting the wireless remote control signals to executing commands and outputting the executing commands;
a digital signal processor configured for receiving the executing commands; and
an image sensor configured for being controlled to obtain image information of a to-be-captured image by the digital signal processor after the digital signal processor receives the executing commands.

2. The camera as claimed in claim 1, wherein the digital signal processor is further configured for outputting a working state signal of the image sensor, and the first microcontroller is further configured for converting the working state signal to a wireless feedback signal and transmitting the wireless feedback signal to the first wireless module to allow the wireless feedback signal to be outputted by the first wireless module.

3. The camera as claimed in claim 2, wherein the first microcontroller is further configured for decrypting the wireless remote control signals after the wireless remote control signals are received and encrypting the wireless feedback signal before outputting the wireless feedback signal.

4. A remote control method of a camera, comprising:
receiving wireless remote control signals;
converting the wireless remote control signals to executing commands; and
controlling an image sensor of the camera to obtain image information of a to-be-captured image according to the executing commands.

5. The remote control method as claimed in claim 4 further comprising:
converting a working state signal of the image sensor to a wireless feedback signal; and
outputting the wireless feedback signal.

6. The remote control method as claimed in claim 5 further comprising decrypting the wireless remote control signals after the step of receiving the wireless remote control signals and encrypting the wireless feedback signal before the step of outputting the wireless feedback signal.

7. A camera system, comprising:
a remote control device configured for outputting wireless remote control signals; and
a camera, comprising:
a first wireless module configured for receiving the wireless remote control signals from the remote control device;
a first microcontroller configured for converting the wireless remote control signals to executing commands and outputting the executing commands;
a digital signal processor configured for receiving the executing commands; and
an image sensor configured for being controlled to obtain image information of a to-be-captured image by the digital signal processor after the digital signal processor receives the executing commands.

8. The camera system as claimed in claim 7, wherein the digital signal processor is further configured for outputting a working state signal of the image sensor, and the first microcontroller is further configured for converting the working state signal to a wireless feedback signal and transmitting the wireless feedback signal to the first wireless module to allow the wireless feedback signal to be outputted by the first wireless module.

9. The camera system as claimed in claim 8, wherein the first microcontroller is further configured for decrypting the wireless remote control signals received by the first wireless module and encrypting the wireless feedback signal.

10. The camera system as claimed in claim 7, wherein the remote control device comprises a second control module, a second microcontroller, and a second wireless module, the second control module is configured for receiving operation commands, the second microcontroller is configured for receiving the operation commands outputted from the second control module and converting the operation commands to wireless remote control signals, and the second wireless module is configured for matching with the first wireless module and transmitting the wireless remote control signals to the first wireless module.

11. The camera system as claimed in claim 8, wherein the remote control device comprises a second control module, a second microcontroller, and a second wireless module, the second control module is configured for receiving operation commands, the second microcontroller is configured for receiving the operation commands outputted from the second control module and converting the operation commands to wireless remote control signals, and the second wireless module is configured for matching with the first wireless module and transmitting the wireless remote control signals to the first wireless module.

12. The camera system as claimed in claim 9, wherein the remote control device comprises a second control module, a second microcontroller, and a second wireless module, the second control module is configured for receiving operation commands, the second microcontroller is configured for receiving the operation commands outputted from the second control module and converting the operation commands to wireless remote control signals, and the second wireless module is configured for matching with the first wireless module and transmitting the wireless remote control signals to the first wireless module.

13. The camera system as claimed in claim 10, wherein the remote control device further comprises a second display, the second wireless module is further configured for receiving the wireless feedback signal outputted from the first wireless module, and the second microcontroller is further configured for converting the wireless feedback signal to an executing state signal and outputting the executing state signal to the second display for display.

14. The camera system as claimed in claim 11, wherein the remote control device further comprises a second display, the second wireless module is further configured for receiving the wireless feedback signal outputted from the first wireless module, and the second microcontroller is further configured for converting the wireless feedback signal to an executing state signal and outputting the executing state signal to the second display for display.

15. The camera system as claimed in claim 12, wherein the remote control device further comprises a second display, the second wireless module is further configured for receiving the wireless feedback signal outputted from the first wireless module, and the second microcontroller is further configured for converting the wireless feedback signal to an executing state signal and outputting the executing state signal to the second display for display.

16. The camera system as claimed in claim 13, wherein the second microcontroller is further configured for encrypting the wireless remote control signals before transmitting the wireless remote control signals and decrypting the wireless feedback signal after the wireless feedback signal is received.

17. The camera system as claimed in claim 14, wherein the second microcontroller is further configured for encrypting the wireless remote control signals before transmitting the wireless remote control signals and decrypting the wireless feedback signal after the wireless feedback signal is received.

18. The camera system as claimed in claim 15, wherein the second microcontroller is further configured for encrypting the wireless remote control signals before transmitting the wireless remote control signals and decrypting the wireless feedback signal after the wireless feedback signal is received.
